(19) United States
(12) Patent Application Publication
(10) Pub. No.: US 2018/0290924 A1
(43) Pub. Date: Oct. 11, 2018

(54) POZZOLANIC CEMENTITIOUS MATERIALS AND METHODS OF MAKING SAME

(71) Applicant: VHSC, LTD., Tortola (VG)

(72) Inventor: Clinton Wesley Pike, SR., Montgomery, TX (US)

(21) Appl. No.: 15/968,857

(22) Filed: May 2, 2018

Related U.S. Application Data
(63) Continuation of application No. 14/715,104, filed on May 18, 2015, now abandoned.

(51) Int. Cl. C04B 18/08; C04B 28/04; C04B 20/02

(52) U.S. Cl. CPC C04B 18/08; Y02W 30/92; C04B 2103/302; C04B 20/023; C04B 28/04

(57) ABSTRACT

A method for accelerating the strength of cement involves providing an activated fly ash processed to increase the surface area of the fly ash and reacting the activated fly ash with a polycarboxylate heteropolymer that acts as a catalyst to produce a pozzolanic cementitious material having as much as a 28% increase in strength (e.g., compressive strength). In one embodiment, the heteropolymer includes hydrophilic and hydrophobic components that assist in providing an optimal equilibrium for the formation of cementitious structures. The increase in strength permits reducing the amount of Portland Cement mixed with the pozzolanic cementitious material to as little as 30%, thus achieving a significant cost reduction.

### CROSS-REFERENCE TO RELATED APPLICATIONS

This patent application is a Continuation of U.S. patent application Ser. No. 14/715,104, filed on May 18, 2015, and titled “Process for Accelerating the Strength of Cement Utilizing a Specialized Water Reducer as a Catalyst,” which is herein incorporated by reference in its entirety.

### FIELD OF THE DISCLOSURE

The present disclosure relates to the manufacture of cement and more particularly to the utilization of a specialized water reducer found to act as a catalyst to strengthen cement.

### BACKGROUND

In the hardening of cement in the past, it has been useful to add a water reducer to strengthen the cement. While polycarboxylate monomers have worked adequately for ordinary cements, when cements are made from activated fly ash in which the surface area of the fly ash is markedly increased, it has been found that polycarboxylate monomers are not as effective due to the lack of reactivity of the relatively short chain.

By way of background, fly ash in its natural state is a heterogeneous material having some glass spheres with their surface coated by numerous salts, potassium (K), sodium (Na), and lithium (Li), and other light metals that are vaporized in the 2,500 to 3,500° F. in the furnace of the power plant boiler. This same heat causes all metals to melt, and thus the spheres are formed because of the eutectic relationships of a finely ground coal with mineral matter entrapped in the coal. Thus, spheres are formed in some cases and non-spherical agglomerations for others.

### SUMMARY

A method for accelerating the strength of cement involves providing an activated fly ash processed to increase the surface area of the fly ash and reacting the activated fly ash with a polycarboxylate heteropolymer produces a pozzolanic cementitious material having as much as a 28% increase in strength (e.g., compressive strength). The increase in strength permits reducing the amount of Portland Cement, sometimes called Ordinary Portland Cement (OPC), mixed with the pozzolanic cementitious material to as little as 30%, thus to achieve a significant cost reduction. As used herein, Portland Cement includes Type I, Type II, and Type III cement.

While not wishing to be bound by theory, it is believed that the largest difference in using a non-ground typical fly ash and the surface-ground material is that for activated fly ash a polycarboxylate heteropolymer has many more surface area sites to react with. It has been found that one can take advantage of the increased number of surface area sites in an activated fly ash if one has a polycarboxylate which is a copolymer as opposed to a monomer. This is because there is a surface area preference for copolymer polycarboxylates due to the number of sites in the copolymer that the activated fly ash can adhere to.

It has been found that a surface area preference for a copolymer in a mixture of cement particles and non-cement (lower calcium) particles results in a greatly expanded reaction. This helps to more easily coalesce particles and to create faster reactions to occur. If the fly ash surface area increases by as little as 10%, one sees a 30%+ increase in strengths when using copolymer polycarboxylates as opposed to monomers. This is due to the above-mentioned increased number of bonding sites between the copolymer chains and the expanded surface area sites of the activated fly ash.

While the subject invention will be described using a multimedia mill rotary grinding to achieve increased fly ash surface area, even non-ground but higher surface area fly ash will react the same way with the specialized polycarboxylate copolymers. Specifically, it has been found that reacting activated fly ash with a polycarboxylate copolymer, such as Polycarboxylate-PCX CAS NO. 59233-52-2, (herein polycarboxylate-PCX) available from WEGO Chemical and Mineral Corporation of Great Neck, N.Y., (herein, WEGO), described as a high-range water reducer, results in an average cement strength increase of 28%.

In addition to the multiplying of the number of sites when utilizing a polycarboxylate heteropolymer such as Polycarboxylate-PCX produced by WEGO, it has also been found that the water/cement ratio can be fixed when using a polycarboxylate such as WEGO Polycarboxylate-PCX. This is because the flowability of the pozzolanic cement mixture is not significantly altered by the use of a polycarboxylate water reducer due to the interaction of the hydrophilic and hydrophobic components of the polycarboxylate water reducer and the fact that more pozzolan and less cement particles are in the mix so that the water/cement ratio remains fairly constant with respect to the cement. This constant water/cement ratio provides an optimal equilibrium for the formation of cementitious structures or crystals and does so without removing water despite the presence of a high-range water reducer.

By way of further background, one way of obtaining activated fly ash involves the use of a multimedia rotary mill and calcium sulfite scrubber residue. As described in U.S. patent application Ser. No. 14/798,527, entitled “Process for Accelerating the Strength of Cement with a Low-Temperature Drying Process for Drying Calcium Sulfite Scrubber Residue from Dry Flue Gas Desulfurization,” filed on even date herewith by Clinton Wesley Pike, Sr. and incorporated herein by reference, calcium sulfite from the residue from desulfurization is utilized to increase the strength of cement. In this process, the residue is added to a multimedia rotary mill to which is added a high-range water reducer. As is the case with most high-range water reducers, they lower the water concentration, and this is supposed to result in higher strength for the cement.

High-range water reducers include polycarboxylate monomers, such as polycarboxylate monomers made by GRESEA Corporation. It was found that the GRESEA water reducer only minimally increased cement strength. It therefore became desirable to find a way to achieve higher cement strengths without having to depend upon reduced water content. What was therefore necessary was to find a new mechanism to increase cement strength in an activated fly ash system without having to rely on traditional monomer-type high-range water reducers and preferably a mechanism independent of water reduction so that flowability would not be impacted.

It has now been found that polycarboxylate copolymers such as Polycarboxylate-PCX manufactured by the WEGO Chemical and Mineral Corporation, in addition to acting as a water reducer, act as a catalyst to achieve higher strength cements when used with activated fly ash.

One way to obtain the increased surface area of fly ash is utilizing a multimedia rotary mill. This multimedia rotary mill is described in U.S. patent application Ser. No. 13/647,838, entitled “Process for Treating Fly Ash and a Rotary Mill Therefor,” filed by Clinton Wesley Pike, Sr. and incorporated herein by reference. Moreover, as described above, calcium sulfite residue from desulfurization processes has been used to increase cement strength. As part of this process, a high-range water reducer was used. While standard high-range water reducers did not result in increased cement strength, the specialized water reducer described here unexpectedly produced exceptional strengthening.

It was found that the WEGO Polycarboxylate-PCX, in particular, in addition to acting as a water reducer, also acts as a catalyst. In one embodiment, a better than 28% strength gain was obtained when using this particular polycarboxylate copolymer, with the strength increase not attributable to simple water reduction, confirming the catalytic action of this specialized polycarboxylate. The net result is that one can achieve increased cement strength without having to rely on traditional high-range water reducers and to do so independent of water reduction.

A preferred polycarboxylate copolymer is the aforementioned Polycarboxylate-PCX, available from the WEGO Chemical and Mineral Corp., having the following chemical structure:

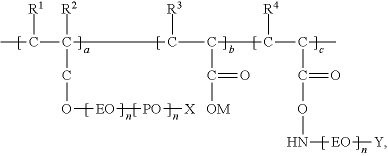

where M, Y, and X are leaving groups, where EO is hydrophilic, and where PO is relatively hydrophobic. The hydrophilic component EO, referring to ethylene oxide, has the following chemical structure:

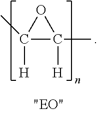

The hydrophobic component PO, referring to propylene oxide, has the following chemical structure:

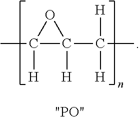

As will be appreciated in light of this disclosure, R¹-R⁴ may be aliphatic carbon chains. As will be further appreciated, variables a, b, c, and n may be whole integers greater than or equal to 1, and carbon bonds omitted from the illustrated chemical structure of WEGO's Polycarboxylate-PCX may be bonded with hydrogen (H). It should be noted that the M, Y, and X leaving groups are proprietary constituents not known outside of WEGO Chemical and Mineral Corp. However, as will be appreciated in light of this disclosure, even without knowing the M, Y, and X leaving groups, a person having ordinary skill in the art can utilize the techniques disclosed herein, including making use of WEGO's commercially available Polycarboxylate-PCX, to produce cementitious material, as variously described herein, in accordance with some embodiments of the present disclosure.

In comparison, a polycarboxylate homopolymer from the GRESEA corporation is:

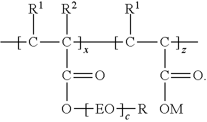

It will be noted that the GRESEA Corporation polycarboxylate is a homopolymer (i.e., made from one type of monomer). From the above formulation, it will be seen that WEGO's Polycarboxylate-PCX is a heteropolymer or copolymer (i.e., made from two monomers), and has a hydrophilic component ethylene oxide, EO, and a hydrophobic component propylene oxide, PO.

As compared to a homopolymer, the polycarboxylate heteropolymers, such as WEGO's Polycarboxylate-PCX, multiplies the number of sites on the copolymer that can react with the increased number of sites made possible by the activation of the fly ash. The number of sites available for reaction on the copolymer exceed by far the number of sites for reaction on the monomer. The net result is a marked increase in strength of cement.

Also, WEGO's Polycarboxylate-PCX has the aforementioned hydrophilic and hydrophobic components, unlike GRESEA Corporation's homopolymer water reducer, which promotes an optimal equilibrium for the formation of cementitious structures due to an optimal water/cement ratio that likewise increases strength.

In summary, what is provided is the use of a catalyst in the form of a polycarboxylate heteropolymer high-range water reducer reacted with activated fly ash to increase the strength of the resulting pozzolanic cementitious material. The strength increase permits utilizing less Ordinary Portland Cement with the pozzolanic cementitious material, thus effectuating cost savings. In one embodiment, the polycarboxylate heteropolymer includes hydrophilic and hydrophobic components to provide an optimal equilibrium for the formation of cementitious structures without altering the water/cement ratio despite the use of a high-range water reducer.

### BRIEF DESCRIPTION OF THE DRAWINGS

These and other features of the Subject Invention will be better understood in connection with the Detailed Description in conjunction with the Drawings, of which:

FIG. 1 is a schematic diagram of one system for providing activated fly ash which also utilizes calcium sulfite scrubber residue in the manufacture of cement through the use of an agglomerator that dewaters the spent absorbent which is heated to less than 250° F., with the dewatered dried sulfite sludge introduced into a multimedia rotary mill where it is, in turn, interground with fly ash and a polycarboxylate water reducer to produce a cement having increased strength, also showing the mixing of the pozzolanic based cement with a reduced amount of Ordinary Portland Cement, OPC, to form a blended cement having 20 to 40% increase strength;

FIG. 2 is a test data chart showing the strength of cement based on raw fly ash, processed fly ash, and fly ash combined with calcium sulfite to show the increase in strength due to low-heat drying of the sulfite sludge; and

FIG. 3 is a diagrammatic representation of a multimedia rotary mill utilized in one embodiment of the subject process in which the mill is provided with tailored media to act differently on aspherical fly ash and spherical fly ash for the purpose of increasing the surface area of the inter-ground output and thus its reactivity.

### DETAILED DESCRIPTION

What is now presented is how the specialized polycarboxylate works as catalyst. As will be seen, the interaction with a surface-modified fly ash of any classification is catalyzed by the above heteropolymer. This is because the heteropolymer has more reaction sites than a monomer and has hydrophilic and hydrophobic groups. It is thought that the hydrophilic reaction is modified by the hydrophobic component such that the polymer does not get into solution as fast because of the hydrophobic component. When used with activated fly ash, the hydrophobic component creates the right balance for cement-like structures to be formed. This keeps the cementitious reaction going because the hydrophobic component prevents solubility. The hydrophobic component thus allows precipitation of cement-like structures without going into solution.

In one embodiment, all of the above processing is accomplished in a multimedia rotary mill. The process involved is described in the aforementioned U.S. patent application Ser. No. 13/647,838. The purpose of the multimedia mill is primarily to provide activated fly ash having a much-increased surface area. As a result of the multimedia mill and WEGO Polycarboxylate-PCX, pozzolanic cementitious material having a Grade 120 slag performance is produced.

As will be shown, the impact of a polycarboxylate copolymer, such as WEGO's Polycarboxylate-PCX, on strength gain is achieved at equal water-to-cement (or w/c) ratios. Moreover, this increase in strength leads to the ability to reduce the amount of Ordinary Portland Cement (OPC) to 30% of the mixture.

The use of a polycarboxylate copolymer, such as WEGO's Polycarboxylate-PCX, constitutes a discovery, as most water reducers lower water content to achieve higher strength gain. On the other hand, it has also been discovered that the addition of a polycarboxylate copolymer, such as WEGO's Polycarboxylate-PCX, results in increased pozzolanic cementitious material strength at equal water ratios, indicating this polycarboxylate copolymer is reacting with the fly ash to achieve superior strengths independent of the water reduction. This, in turn, causes the pozzolanic cementitious material to gain strength without having to consider water content, as seen by the table below. Tests for compressive strength were run as per ASTM C109 protocol.

TABLE 1

| | | | | |
|---|---|---|---|---|
| | 85.3% RMACason/8LSRMA/5.5% Pkslg/1Qlime/0.20Poly: | 175 | 111 | 2307 |
| Mar. 2, 2015 | 85.5% RMACason/8LSRMA/5.5% Pkslg/1Qlime/0.00Poly: | 175 | N/A | 1150 |
| Mar. 3, 2015 | 85.5% RMACason/8LSRMA/5.5% Pkslg/1Qlime/0.00Poly: | 205 | 107 | 1307 |
| Mar. 3, 2015 | 85.3% RMACason/8LSRMA/5.5% Pkslg/1Qlime/0.20Poly: | 205 | N/A | 1675 |

The above chart shows a low water content (175) test with activated fly ash reacted with the Polycarboxylate-PCX and without reacting with polycarboxylate, but having equal water contents (175). It also shows a high water content (205) test showing that in either case with equal water contents, WEGO's Polycarboxylate-PCX outperforms the situation in which no polycarboxylate is used. Thus, with respect to the low water content test, the strength of 2307 for WEGO's Polycarboxylate-PCX usage exceeds the strength of 1154 for no polycarboxylate. Likewise, for the high water content test, the strength of 1675 when using WEGO's Polycarboxylate-PCX exceeds the strength of 1307 for no polycarboxylate.

It is apparent that from the above tests and with a low water content of 175 the resulting cement meets the ASTM requirements on the flow table at measured flow of 111 when utilizing a polycarboxylate such as WEGO's Polycarboxylate-PCX. However, the cement is too viscous to measure when considering the non-treated sample that has too low a flow with a minimum of 105.

Note that the polycarboxylate copolymer addition greatly enhances the strengths of identical samples. However, at the same water cement ratio in the higher water content 205 test, with the flow table of 107 for the non-poly treated sample at the same water content, the polycarboxylate copolymer still gave a better than 28% strength gain as opposed to performance at the lower w/c ratio. This reaction with the polycarboxylate copolymer shows results that are better than the results with water reduction only. As a result, this strength gain with the polycarboxylate copolymer far exceeds that attributable to just water reduction and substantiates the conclusion that the polycarboxylate copolymer is a catalyst.

In one embodiment, the polycarboxylate is introduced into a multimedia rotary mill environment in which the polycarboxylate is used along with calcium sulfite residue from a desulfurization process. This multimedia rotary mill process with calcium sulfite residue is now described.

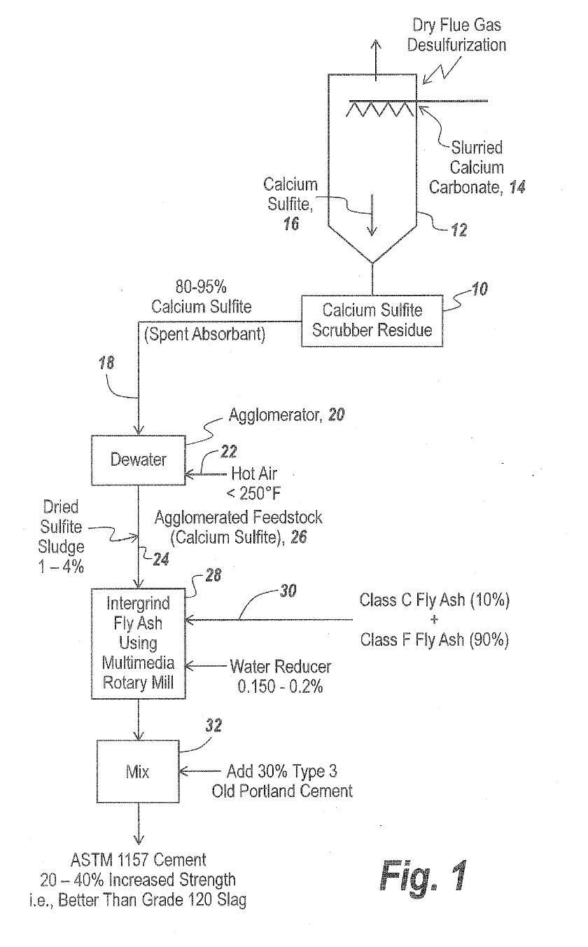

Referring now to FIG. 1, a process is shown for utilizing calcium sulfite scrubber residue in the manufacture of cement. The calcium sulfite residue 10 is the result of the desulfurization process in a chamber 12 which desulferizes dry flue gas by the injection of slurried calcium carbonate 14 in a downward direction where the calcium carbonate reacts with upwardly directed flue gas such that the reaction produces calcium sulfite 16.

The calcium sulfite is in the form of a moist spent absorbent, with the absorbent containing 80-95% calcium sulfite. This is conveyed by conduit 18 to an agglomerator 20, the purpose of which is to dry the moist scrubber residue in a dewatering process in which hot air 22 is introduced into the agglomerator 20 specifically at a temperature less than 250° F. The result is a dried sulfite sludge available at conduit 24 which constitutes an agglomerated feedstock of calcium sulfite 26. In one embodiment, this dried sulfite sludge is introduced into a multimedia rotary mill 28 in which a supply of fly ash is introduced by conduit 30. The dried sludge is introduced at 1-6% by weight into the multimedia rotary mill 28, with the polycarboxylate water reducer 32 introduced into the multimedia rotary mill 28 at 0.150-0.2% in one embodiment. The output of the multimedia rotary mill 28 is introduced to a mixer 32 to which is added 30% Type III Ordinary Portland Cement to produce an ASTM 1157 cement having a 20-40% increased strength with a better than Grade 120 Slag performance.

The increased strength is due to the action of the sulfite when mixed with fly ash in the presence of the polycarboxylate water reducer. The subject process, in one embodiment, uses either Class C fly ash or Class F fly ash, or in a preferred embodiment of 10% Class C fly ash and 90% Class F fly ash.

Note that in the process of producing activated slag utilizing the multimedia rotary mill, known as POZZOSLAG® cement, it was discovered that calcium sulfite dried at under 250° F. when added to the mix at 0.5-10% depending on the type of fly ash being processed can enhance the strength of the cement/pozzolan mixture by 20-40% as opposed to any typical additive. It is important to note that the drying process has to operate at a low temperature which does not affect downstream strengthening, for instance, below 250° F. If the temperature is above 250° F., the calcium sulfite does not provide better strength gains.

From the test results presented below, several different types of fly ash exhibited very substantial increases in strength.

For those fly ashes to which no dried sulfite sludge was added, they did not reach a Grade 80 slag performance. However, when calcium sulfite was added in the ranges described above, all test cubes exceeded the Grade 120 slag performance requirement under the ASTM C989 testing protocol. Note that tests are run on a number of fly ash materials that could not pass the grade 80 slag index, but after utilization of the dry calcium sulfite residue, they began to pass the Grade 120 slag performance requirement due to the increase in strength of the cement. In the process described above, no unique material was noted in X-ray diffraction (XRD) examination, and thus no reactionary trace materials were found. Not only was it discovered that one has to dry the scrubber sludge at a fairly low temperature, it was also discovered that it is beneficial to utilize a very strong water reducer at 0.150-0.2%, such as WEGO's Polycarboxylate-PCX, to obtain the increased rates in an ASTM cube testing procedure. Without the drying procedure described above as well as the use of the specialized water reducer, any increase in strength due to the use of the sludge is not enough to consider.

Further cube strength testing even when using a fly ash that has a surface area only increased by 15-20% by the unique multimedia rotary mill, one can nevertheless obtain Grade 120 slag performance. This can be done with a 70% replacement of Ordinary Portland Cement with POZZOSLAG® cement and the remainder a structural filler comprising 8% of a ground-down silica filler with a 9-16 micron mean, with 60% passing 10 microns, and a top size of 35 microns.

It also was found that by using 10% by weight of ASTM Class C fly ash blended with Class F fly ash, the addition of the Class C fly ash to Class F fly ash not only results in the aforementioned strength increase, but it also allows one to spend less time in the rotary mill to achieve the same results in activity. This means that the resulting cement passes the Grade 120 slag activity with only 20 minutes in the rotary mill as opposed to 50 minutes. The increased strength cement can thus be produced in less than half the time.

Note that all Class C fly ashes tested have 0.2% or less polycarboxylate content and a 20% surface area increase. With just 1-4% of the 250° F. dried sludge and polycarboxylate, a well over Grade 120 activity is produced with no structural filler.

The surprising result of the invention described in the above-mentioned patent application is that with sulfite, there is an optimal drying temperature, and that by providing a mixture of Class C and Class F fly ash, one can maximize the sulfite results. Thus, it has been found that if the base pozzolan is a Class F fly ash, one can add up to 15% Class C fly ash, with the 1-6% sulfite concentration optimizing strength. If on the other hand one is using a Class C fly ash, 1-6% sulfite concentrations maximize strength, although there is a need for other chemical changes. Specifically, one needs to balance the chemistry, given the amount of alkali in the mix, to make an Alkali Sulfate Resistant (ASR) concrete. In order to do so, one has to remove 10-15% of the Class C fly ash and add in its place a Class F fly ash or a mineral filler. The mineral filler, in one embodiment, is a sand ground down to about 15 micron mean particle size, with 60% under 10 microns and a top size of 30-35 microns. In short, there must be a minimum of 10-15% either of all fly ash or all mineral filler or a 50%/50% combination of each. Note that the silica sand gives flexibility to allow one to produce one's own additive if no Class F fly ash is available.

Regardless, given that the mixture passes ASR tests, mainly ASTM C441, in which one has to have a 75% minimum passing reactivity, the subject process results in obtaining an 80-85% reactivity. This means that one can safely pass the ASR tests while meeting the Grade 120 slag or better performance.

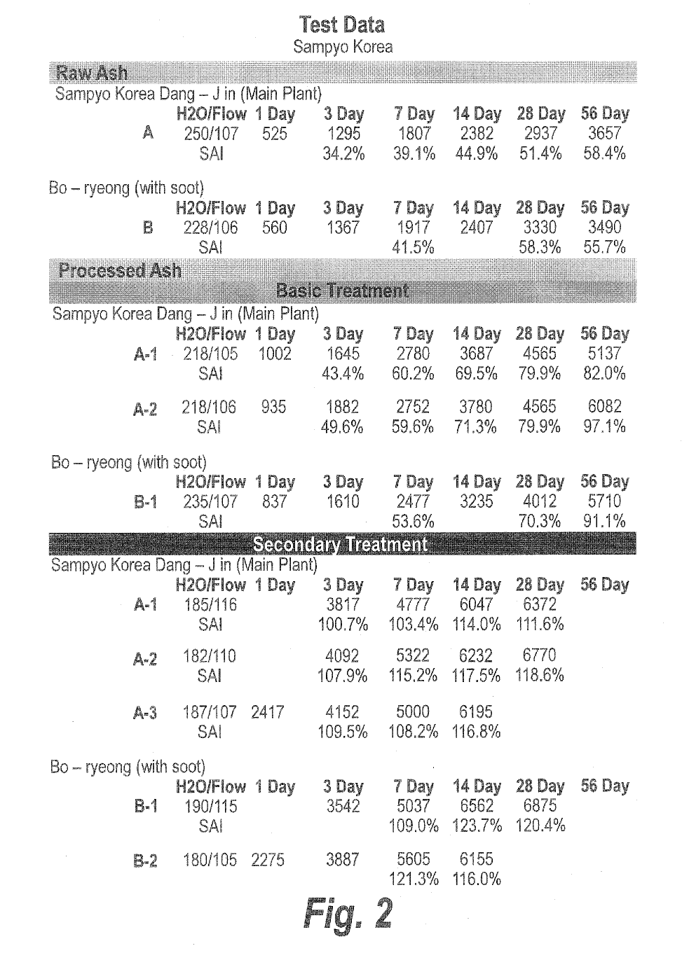

As to the test results and referring now to FIG. 2, it can be seen that fly ash from Sampyo Korea Dang and Bo-ryeong was used. Note that Sampyo Korea Dang fly ash J in the main plant was used, whereas in Bo-ryeong, the fly ash contained soot. From the Test Data of FIG. 2, it will be seen that this data is arranged by raw ash, meaning untreated ash, processed ash, meaning processed in a multimedia rotary mill, and the secondary treatment, which refers to processing in the multimedia rotary mill with the subject calcium sulfite derived from desulfurization.

In the Table of FIG. 2, samples from two plants, namely Sampyo Korea Dang and Bo-ryeong, are separately presented for raw ash, processed ash, and secondary treatment processes. These samples are labeled A, B, A-1, A-2, A-3, B-1 and B-2.

For each of the samples, the H2O/flow is indicated having allowable parameters, with the one-day, three-day, seven-day, 14-day, 28-day, and 56-day tests indicating in terms of pounds per square inch (psi) the amount of pressure to cause a test cube of the corresponding cement to fail. The following describes the strength increase only for the 28^{th}-day figures analyzed, with the failure psi for each test cube followed by the Strength Activity Index (SAI). Note that the SAI is expressed in terms of a percent strength when compared with a test cube of pure cement. Thus, an SAI of 120.4% means that there is a 20.4% increase in strength over a test cube of pure cement. With this understanding, the results of the Table in FIG. 2 are now discussed.

As can be seen, the SAI is the principal measure of strength used here. For purposes of comparison taking the 28^{th}-day strength, with raw ash for both the plants, the SAI was respectively 51.4% and 58.3%, meaning that the 28^{th}-day strength was only 51-58% of pure cement. For processed ash, meaning processed in a multimedia rotary mill, the 28^{th}-day strength was around 79.9% and 70.3% respectively. Comparing this to utilization of dried calcium sulfite sludge, 28^{th}-day strengths for Sampo Korea Dang were either 111.6% or 118.6% and for Bo-ryeong it was 120.4%. This means that the cements averaged strengths of between 111.6% and 120.4%. From a percentage increase point of view, this translates to a 20-40% strength increase. The remainder of the data for one-day, three-day, five-day, 14-day, 28-day, and 58-day measurements shows like increases when using calcium sulfite sludge.

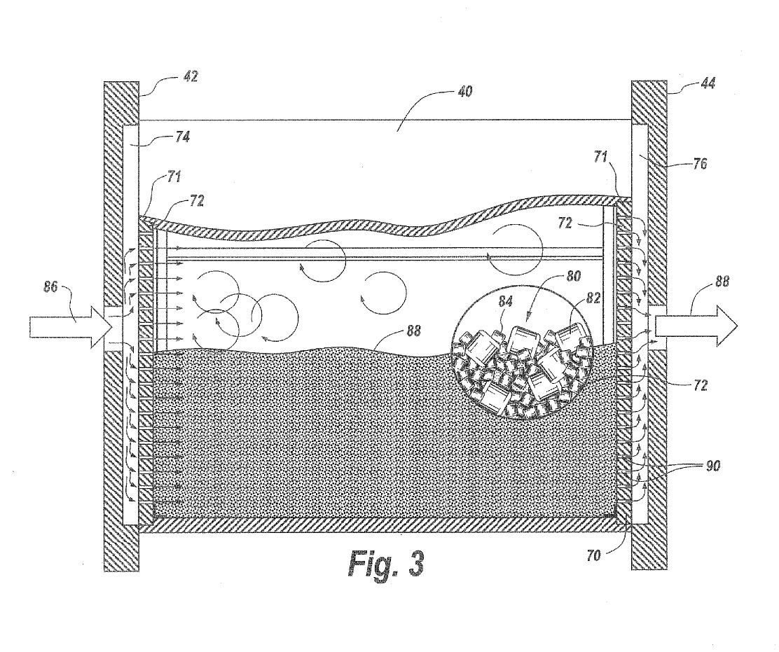

Referring now to FIG. 3, what is shown is a diagrammatic illustration of a specialized rotary mill having a tailored media which operates differently on, for instance, aspherical fly ash and spherical fly ash to increase the surface area thereof. Note that to increase the surface area of fly ash, the multimedia rotary mill employs different sizes and shapes of ceramic media. It has been found that fly ash can be rotary milled to achieve a total specific surface area of around 1.263 m²/g or higher starting at 0.695 m²/g. Thus, one can increase the surface area of all particles and especially the spherical particles.

The surface area of both non-spherical and spherical particles can be increased by crushing non-spherical particles and by roughing up the surface of the spheres. Both types of particles are treated in the mill using a tailored mix of ceramic media. Thus, while one is not actually fracturing the small spherical particles, the mill nonetheless beats them up utilizing the tailored media so as to increase the surface area of small spherical particles to activate them while at the same time grinding non-spherical particles to a smaller and smaller diameter to provide increased surface area.

Note that rotary mill 10 is filled with a multimedia charge. Drum 40 is shown with slotted plates 71 that communicate with an input plenum 74 and output plenum 76 through end plates 42 and 44. Drum 40 is preloaded with a tailored charge of ceramic media, here shown at 80, to include different sized ceramic media 82 and 84. The formulation determines the amount of grinding of the fly ash introduced into drum 40 as illustrated at 86 and occupies at least one third of the volume of drum 40 as illustrated at 88.

In one embodiment, when the pre-ground fly ash has been ground by the rotary mill for 45 minutes, the activated fly ash 88 is ejected through slits 42 in exit plate 71.

As to the constituency of the multimedia, this formulation can be tailored as indicated above. In one example, the formula for the media may include one-half inch cylindrical ceramic media, ¼ inch cylindrical ceramic media, three-quarter inch cone shaped ceramic media, and 8 mm beads. In another formulation, one can use a mixture of ⅝ inch cylinders with three-quarter inch cones and ⅛ inch cylinders, it being understood that there are many different media combinations that may be used in combination with different types of fly ash and different residence times. For instance, depending on the media formulation, one can lower the residence time from, for instance, one hour to less than 45 minutes.

Thus, rotary mill 40 can create multiple components differently depending on the mix of media in the mill and the configuration thereof. Specifically, with respect to the treatment of preground fly ash to provide activated fly ash, the differently configured media acts differently on the aspheric fly ash as opposed to the spherical beads. In the case of aspherical fly ash particles, they are further ground down without cracking or grinding any spherical fly ash particles. On the other hand, the spherical glass beads are polished to rough of their surfaces. In both cases, the surface area of fly ash particles is increased. Thus, for the aspherical particles, the increased surface area is performed by grinding, whereas for the glass beads, the increased surface area is roughened by roughening up the surface of the beads.

Although this specialized rotary mill has been shown to be able to provide cement having a slag performance equal to or better than Grade 120 slag performance, the mill can be made to produce stronger cement and, to the extent that it can be made stronger, less Portland Cement needs to be mixed with it in order to provide the requisite slag performance. Thus, strength increase is key to the reduction of the amount of conventional Portland Cement that needs to be used, with the subject strength increase coming from the specially dried calcium sulfite scrubber residue, in plentiful supply from desulfurization processes associated with boilers and power plants.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method of making a pozzolanic cementitious material, the method comprising:
providing an activated fly ash that has been processed to increase a surface area thereof;
reacting a polycarboxylate heteropolymer high-range water reducer with the activated fly ash, wherein the polycarboxylate heteropolymer high-range water reducer comprises a hydrophilic component and a hydrophobic component that provide for a water/cement ratio of the pozzolanic cementitious material which is unaltered despite the presence of the polycarboxylate heteropolymer high-range water reducer and which provides for formation of cementitious structures without removing water; and
mixing the activated fly ash and the polycarboxylate heteropolymer high-range water reducer with ordinary Portland cement.

2. The method of claim 1, wherein the polycarboxylate heteropolymer high-range water reducer constitutes between 0.15-0.2% by weight of the pozzolanic cementitious material.

3. The method of claim 1, wherein at least one of:
the hydrophilic component is ethylene oxide; and
the hydrophobic component is propylene oxide.

4. The method of claim 1, wherein the polycarboxylate heteropolymer high-range water reducer has a chemical structure of 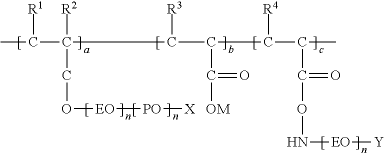
wherein:
R¹, R², R³, and R⁴ are aliphatic carbon chains;
X, M, and Y are leaving groups;
EO is ethylene oxide;
PO is propylene oxide;
a, b, c, and n are whole integers greater than or equal to 1; and
carbon bonds omitted from the chemical structure are bonded with hydrogen.

5. The method of claim 1, wherein the activated fly ash comprises Class C fly ash and Class F fly ash.

6. The method of claim 5, wherein:
the Class C fly ash constitutes up to 50% by weight of the activated fly ash; and
the Class F fly ash constitutes up to 50% by weight of the activated fly ash.

7. The method of claim 5, further comprising:
mixing the activated fly ash with a calcium sulfite material.

8. The method of claim 7, wherein the calcium sulfite material comprises a dried sulfite sludge containing between 80-95% calcium sulfite.

9. The method of claim 8, wherein the dried sulfite sludge constitutes between 1-6% by weight of the pozzolanic cementitious material.

10. The method of claim 7, wherein the calcium sulfite material constitutes between 0.5-10% by weight of the pozzolanic cementitious material.

11. The method of claim 10, wherein:
the polycarboxylate heteropolymer high-range water reducer constitutes between 0.15-0.2% by weight of the pozzolanic cementitious material;
the activated fly ash comprises:
Class C fly ash constituting up to 50% by weight of the activated fly ash; and
Class F fly ash constituting up to 50% by weight of the activated fly ash; and
the ordinary Portland cement constitutes as little as 30% by weight of the pozzolanic cementitious material.

12. The method of claim 1, wherein the ordinary Portland cement constitutes as little as 30% by weight of the pozzolanic cementitious material.

13. The method of claim 12, wherein the ordinary Portland cement comprises at least one of Type I, Type II, and Type III ordinary Portland cement.

14. The method of claim 1, further comprising:
mixing the activated fly ash, the polycarboxylate heteropolymer high-range water reducer, and the ordinary Portland cement with a structural filler comprising a ground-down silica filler.

15. The method of claim 14, wherein the structural filler constitutes 8% by weight of the pozzolanic cementitious material.

16. The method of claim 14, wherein the ground-down silica filler has a mean particle size of between 9-16 microns, with 60% passing 10 microns, and a top size of 35 microns.

17. The method of claim 1, further comprising:
mixing the activated fly ash, the polycarboxylate heteropolymer high-range water reducer, and the ordinary Portland cement with a mineral filler comprising a ground-down sand filler.

18. The method of claim 17, wherein the ground-down sand filler has a mean particle size of 15 microns, with 60% under 10 microns, and a top size of between 30-35 microns.

19. The method of claim 1, wherein the pozzolanic cementitious material exhibits a compressive strength that exceeds a compressive strength which otherwise would be obtained by mixing a non-heteropolymer high-range water reducer with the activated fly ash at an identical water/cement ratio to that of the pozzolanic cementitious material, wherein the compressive strength of the pozzolanic cementitious material is determined in accordance with ASTM C109 testing protocol.

20. The method of claim 1, wherein the pozzolanic cementitious material has a better than Grade 120 slag performance as determined in accordance with ASTM C989 testing protocol.
